(19) United States
(12) Patent Application Publication
(10) Pub. No.: US 2018/0117970 A1
(43) Pub. Date: May 3, 2018

(54) Tire Reinforcement

(71) Applicant: COMPAGNIE GENERALE DES ETABLISSEMENTS MICHELIN, Clermont-Ferrand (FR)

(72) Inventors: Christophe LE CLERC, Clermont-Ferrand Cedex 9 (FR); Jacky PINEAU, Clermont-Ferrand Cedex 9 (FR); Richard CORNILLE, Clermont-Ferrand Cedex 9 (FR)

(21) Appl. No.: 15/567,303

(22) PCT Filed: Apr. 11, 2016
(86) PCT No.: PCT/EP2016/057911

§ 371 Date: Oct. 17, 2017

(30) Foreign Application Priority Data
Apr. 17, 2015 (FR) 1553420

(51) Int. Cl. B60C 9/20; B60C 9/07

(52) U.S. Cl. CPC B60C 9/2009; B60C 2009/2261; B60C 9/07

(57) ABSTRACT

Hooping layer (71) of a passenger vehicle tire has a force at break FR per mm of axial width of the hooping layer at least equal to 35 daN/mm, an elongation at break AR at least equal to 5%, and a secant extension modulus MA at least equal to 250 daN/mm, for an applied force F equal to 15% of FR. Working reinforcement (6) comprises single working layer (61) the working reinforcers of which form, with circumferential direction (YY′), an angle A_{T} at least equal to 30° and at most equal to 50°. The carcass reinforcers of at least one carcass layer (81) form, with circumferential direction (YY′) and in equatorial plane (XZ), angle A_{C2} at least equal to 55° and at most equal to 80° and having an orientation opposite to angle A_{T} of the working reinforcers so that the carcass reinforcers and the working reinforcers constitute a triangulation.

The subject of the invention is a tire for a passenger vehicle, commonly referred to as a passenger vehicle tire, and, more particularly, the reinforcement thereof.

Since a tire is a toric structure the axis of revolution of which is the axis of rotation of the tire, the terminologies used for the present invention are as defined hereinbelow:
“axial direction”: direction parallel to the axis of rotation of the tire,
“radial direction”: direction perpendicular to the axis of rotation of the tire,
“circumferential direction”: direction perpendicular to a radial plane containing the axis of rotation of the tire,
“radial plane”: plane containing the axis of rotation of the tire,
“equatorial plane”: plane perpendicular to the axis of rotation and passing through the middle of the tread.

A tire usually comprises a tread intended to come into contact with the ground and connected, at its axial ends, radially towards the inside, via two sidewalls, to two beads intended to come into contact with a rim. The radial distance between the radially outermost point of the tread and the straight line passing through the radially innermost points of the beads, with the tire mounted on its rim, is referred to as the height H of the tire.

A radial tire further comprises a reinforcement comprising, radially from the outside towards the inside, at least one working reinforcement and one carcass reinforcement.

The working reinforcement, radially on the inside of the tread, comprises at least one working layer comprising working reinforcers coated in an elastomeric material, the said working reinforcers forming, with the circumferential direction, an angle at least equal to 10°. Usually, the working reinforcement of a passenger vehicle tire comprises two working layers, the respective working reinforcers of which are crossed from one working layer to the next, so as to create a triangulation. Generally, the working reinforcers, for a passenger vehicle tire, are made of a metallic material, usually steel, and are formed of a collection of threads, referred to as a cord, or of a single thread.

The carcass reinforcement, radially on the inside of the working reinforcement, connects the two beads of the tire, generally by being wrapped, within each bead, around a circumferential reinforcing element or bead wire, and comprises at least one carcass layer comprising carcass reinforcers coated in an elastomeric material. In the case of a passenger vehicle tire, the carcass reinforcement generally comprises a single carcass layer. In the most frequently encountered case of a radial carcass reinforcement, the carcass reinforcers form, with the circumferential direction, at every point on the carcass layer, an angle at least equal to 85°. Generally, the carcass reinforcers, for a passenger vehicle tire, are made of a textile material such as, by way of nonexhaustive examples, an aliphatic polyamide or nylon, an aromatic polyamide or aramid, a polyester such as a polyethylene terephthalate (PET), a textile material comprising cellulose fibres such as rayon.

Often, the reinforcement also comprises a hoop reinforcement. A hoop reinforcement is adjacent to the working reinforcement, namely radially on the outside of the working reinforcement or radially on the inside of the working reinforcement. The hoop reinforcement is generally radially on the outside of the carcass reinforcement. It comprises at least one hooping layer, and usually a single hooping layer. A hooping layer comprises hoop reinforcers, coated in an elastomeric material and forming, with the circumferential direction, an angle at most equal to 5°. The hoop reinforcers, for a passenger vehicle tire, may be made either of a textile material or of a metallic material.

The assembly formed by the working reinforcement and the hoop reinforcement constitutes the crown reinforcement of the tire.

While it is in use, a passenger vehicle tire may run over foreign bodies that pierce its tread and are liable to partially or fully rupture the working layers. This is chiefly due to the high stiffness, particularly radial stiffness, of the working reinforcement. For a conventional tire of the prior art, the high deformations imposed by the piercing by such objects are essentially supported by the working reinforcement, but not by the carcass reinforcement.

U.S. Pat. No. 4,310,043 already discloses a radial tire intended for vehicles of the heavy duty type, having a high resistance to bursting under the effect of shocks which may occur when passing over a stone. Such a tire notably comprises a carcass reinforcement, not having excessive mechanical strength and comprising at least one carcass layer which may comprise textile reinforcers, and a working reinforcement, radially on the outside of the carcass reinforcement, comprising three working layers the two radially outermost ones of which comprise metal reinforcers forming, with respect to the circumferential direction, an angle of between 15° and 25°.

Aside from foreign bodies piercing the crown of tire and potentially causing the crown to become punctured and ruptured, repeated stress loadings on the crown as a result, for example, of running over ground covered with cobbles have a hammering effect on the crown and may lead to mechanical fatigue in the crown reinforcers and, potentially, rupture thereof.

The inventors have set themselves the objective of designing a passenger vehicle tire that has both good resistance to the penetration and perforating of its crown by foreign objects liable to pierce the said crown, and good resistance to fatigue when the crown is subjected to hammering, with a reinforcement design that is simpler and more lightweight than that of a passenger vehicle tire of the prior art.

Therefore, the subject of the invention is a passenger vehicle tire comprising:
a tread intended to come into contact with the ground and connected, at its axial ends, radially towards the inside, via two sidewalls, to two beads intended to come into contact with a rim,
a working reinforcement, radially on the inside of the tread, and comprising at least one working layer comprising metal working reinforcers coated in an elastomeric material, the said working reinforcers forming, with a circumferential direction of the tire, an angle A_{T} at least equal to 10°,
a hoop reinforcement, radially on the inside of the tread, and radially adjacent to the working reinforcement, and comprising a single hooping layer comprising hoop reinforcers coated in an elastomeric material, the said hoop reinforcers forming, with the circumferential direction, an angle A_{F} at most equal to 5°,
a carcass reinforcement, joining the two beads together, radially on the inside of the working reinforcement and of the hoop reinforcement, and comprising at least one carcass layer comprising textile carcass reinforcers coated in an elastomeric material, the said carcass reinforcers forming, with the circumferential direction, at least partially in the sidewalls, an angle A_{C1} at least equal to 85°,
the hooping layer having a force at break per mm of axial width of the hooping layer FR at least equal to 35 daN/mm,
the hooping layer having an elongation at break AR at least equal to 5%,
the hooping layer having a secant extension modulus MA at least equal to 250 daN/mm, for an applied force F equal to 15% of the force at break FR of the said hooping layer,
the working reinforcement comprising a single working layer the working reinforcers of which form, with the circumferential direction, an angle A_{T} at least equal to 30° and at most equal to 50°,
and the carcass reinforcers of the at least one carcass layer forming, with the circumferential direction and in the equatorial plane, an angle A_{C2} at least equal to 55° and at most equal to 80° and having an orientation the opposite of that of the angle A_{T} of the working reinforcers so that the carcass reinforcers and the working reinforcers constitute a triangulation.

A tire according to the invention is characterized by a reinforcement comprising:
a hoop reinforcement, made up of a single hooping layer, the hooping layer having a specified minimal force at break FR, expressed in daN per mm of axial width of the hooping layer, a specified minimum elongation at break AR, and a specified minimum secant extension modulus MA, for an applied force F equal to 15% of the force at break FR of the said hooping layer, the said secant extension modulus MA being the ratio between 15% of the force at break FR and the corresponding elongation,
a working reinforcement made up of a single working layer the metal working reinforcers of which form, with the circumferential direction, an angle A_{T} at least equal to 30° and at most equal to 50°,
a carcass reinforcement, usually made up of a single carcass layer, the carcass reinforcers of which form, with the circumferential direction and in the equatorial plane, an angle A_{C2} at least equal to 55° and at most equal to 80° and having an orientation the opposite of that of the angle A_{T} of the working reinforcers so that the carcass reinforcers and the working reinforcers constitute a triangulation.

The essential differences between the invention and a passenger vehicle tire of the prior art are therefore:
a hoop reinforcement with a single hooping layer having at once a higher force at break, a higher elongation at break, and a higher tensile stiffness,
a working reinforcement with a single working layer in place of two working layers the working reinforcers of which are crossed from one layer to the other,
and a carcass reinforcement with a carcass layer that is not radial in the crown portion so that the carcass reinforcers and the working reinforcers are crossed relative to one another.

The inventors have been able to observe that, surprisingly, the reinforcement according to the invention, even though it comprises one fewer working layer by comparison with the prior art, which means to say even though it is simpler and more lightweight, guarantees better resistance to penetration by an indenting body. In this case, the triangulation between the working layer and the carcass layer, which is associated with a hooping layer that is both stronger and stiffer, allows the tire more effectively to absorb the energy of deformation imposed by the piercing object, with less degradation of the reinforcement in the crown region. More particularly, the choice of physical characteristics of the hooping layer makes it possible better to control the deformed profile of the crown of the tire and therefore avoid any excessive deformation that could lead to early damage during running.

This advantage was quantified by a perforation test referred to as a “breaking energy” test, which is a standardized static test involving measuring the energy needed to perforate a tire mounted, inflated, on its rim, using a metal cylinder referred to as polar and having a diameter equal to 19 mm, the tire being subjected to a nominal given load or weighted load (overload) A nominal load is a standardized load defined by the European Tire and Rim Technical Organisation or ETRTO standard.

In addition, the inventors have also been able to observe that, surprisingly, this reinforcement according to the invention, even though it comprises one fewer working layer by comparison with the prior art, this single working layer however being coupled to a hooping layer having an elongation at break at least equal to 5%, offers crown fatigue strength performance of the same order of magnitude as the prior art when driving a route over ground covered with cobbles. In this instance, this lightened crown design leads to deformations of the hoop reinforcers that are locally greater in extension and in compression. The hooping layer also needs to have stiffness and force at break levels that are high enough for the tire to be able to withstand the usual stress loadings, hence the need for a specific compromise between force at break, elongation at break, and the extension modulus of the hooping layer.

This advantage was quantified by very harsh tests of running over cobbles. An 8000 km journey, at 30 km/h, over a track covered with cobbles was conducted by a vehicle fitted with 4 test tires of size 205/55/R16, inflated to 2.2 bar, and subjected to their nominal load, within the meaning of the European Tire and Rim Technical Organisation standard. At the end of running, each tire was de-capped, which means to say that its tread was removed, and the number of zones in which the hoop reinforcers had broken was counted.

As far as the carcass reinforcement is concerned, the carcass layer is substantially radial in at least part of the sidewalls, which means to say that the carcass reinforcers form, with the circumferential direction, an angle at least equal to 85°. More specifically, the portion of sidewall to which this radial orientation of the carcass layer preferably relates extends radially between the axial straight lines positioned respectively at radial distances of 3H/8 and of H/8 away from the radially outermost point of the tread of the tire.

For preference, the hooping layer has a force at break per mm of axial width of the hooping layer FR at least equal to 45 daN/mm, thereby guaranteeing the hooping layer better force at break.

More preferably still, the hooping layer has an elongation at break AR at least equal to 5.5%, thereby further improving the fatigue strength of the hoop reinforcers.

Preferably also, the hooping layer has a secant extension modulus MA at least equal to 300 daN/mm, for an applied force F equal to 15% of the force at break FR of the said hooping layer, thereby guaranteeing the hooping layer greater tensile stiffness.

Advantageously, the hooping layer has a secant extension modulus MA at most equal to 900 daN/mm, for an applied force F equal to 15% of the force at break FR of the said hooping layer. This guarantees a low number of zones in which the hoop reinforcers are broken during harsh running over a track covered in cobbles.

Advantageously also, the hooping layer has a secant extension modulus MA at most equal to 700 daN/mm, for an applied force F equal to 15% of the force at break FR of the said hooping layer. This guarantees a very low number of zones in which the hoop reinforcers are broken during harsh running over a track covered in cobbles, at the level of that observed for a tire of the prior art comprising two working layers the respective working reinforcers of which are crossed from one layer to the next.

With the hooping layer comprising hoop reinforcers having a diameter D and spaced one from the next by an inter-reinforcer distance L, the ratio D/L between the diameter D of a hoop reinforcer and the distance L separating two consecutive hoop reinforcers is advantageously at least equal to 1 and at most equal to 8. For a D/L ratio greater than 8, the hoop-reinforcers density far exceeds what is required in terms of the mechanical strength of the hooping layer and the quantity of interstitial elastomeric material comprised between two consecutive hoop reinforcers is correspondingly insufficient. For a D/L ratio lower than 1, the hooping layer is difficult to manufacture on industrial tooling producing wide widths.

For preference, with the hooping layer comprising hoop reinforcers having a diameter D and spaced one from the next by an inter-reinforcer distance L, the ratio D/L between the diameter D of a hoop reinforcer and the distance L separating two consecutive hoop reinforcers is at least equal to 2 and at most equal to 5. A D/L ratio comprised within this interval guarantees that there will be an optimal amount of elastomeric material present with respect to the mechanical strength of the interstitial elastomeric material, thereby giving the hooping layer satisfactory robustness.

According to a first embodiment relating to the material of the hoop reinforcers, the hoop reinforcers comprise a textile material such as an aromatic polyamide or aramid, an aliphatic polyamide or nylon, a polyester such as a polyethylene terephthalate (PET), a polyethylene naphthenate (PEN), a polyketone or a textile material comprising cellulose fibres such as rayon or lyocell. Hoop reinforcers made of textile material offer the advantages of lightness of weight and ability to withstand moisture.

According to a second embodiment relating to the material of the hoop reinforcers, the hoop reinforcers comprise a combination of at least two distinct textile materials. Hoop reinforcers comprising a combination of at least two distinct textile materials, also referred to as hybrid hoop reinforcers, have the particular feature of having a tensile curve, representing the tensile force applied to the reinforcer as a function of the elongation thereof, that may exhibit a relatively low first tensile elastic modulus at low elongations and a higher second tensile elastic modulus at high elongations, which is why such reinforcers are said to exhibit “bi-modulus” behaviour. The relatively low first tensile elastic modulus contributes to the robustness of manufacture of the tire. The higher second tensile elastic modulus provides a response to the need for the tire to have mechanical strength in service.

In a preferred alternative form of the second embodiment relating to the material of the hoop reinforcers, the hoop reinforcers are made of a combination of an aromatic polyamide or aramid and of a polyethylene terephthalate (PET). This is the combination which in testing has yielded the best results with regard both to resistance to perforation and fatigue strength of the crown under the effect of hammering.

With the hooping and working layers respectively having an axial width L_{F} and L_{T}, the hooping layer preferably has an axial width L_{F} less than the axial width L_{T} of the working layer, preferably when the hooping layer is radially on the outside of the working layer. The hooping layer is narrow in comparison with the working layer because its function is essentially to limit radial movements of the crown in the region of the equatorial plane, at the centre of the tread of the tire. This configuration is particularly advantageous when the hooping layer is radially on the outside of the working layer. However, in instances in which the hooping layer is radially on the inside of the working layer, the axial width L_{F} of the hooping layer may, if appropriate, be greater than the axial width L_{T} of the working layer.

For preference, the working reinforcers of the working layer form, with the circumferential direction, an angle A_{T} at least equal to 35° and at most equal to 45°. This range of angular values corresponds to the optimum for guaranteeing the tire sufficient cornering stiffness which is needed for the tire to behave correctly during running with bends. The cornering stiffness of a tire corresponds to the axial force that has to be applied to the tire to generate a 1° rotation about a radial direction.

More preferably still, the carcass reinforcers of the at least one carcass layer form, with the circumferential direction and in the equatorial plane (XZ), an angle A_{C2} at least equal to 60° and at most equal to 70°. This range of angular values is the result of the shaping of the tire during its manufacture. The reinforcers of the carcass layer are initially radial, which means to say form an angle close to 90° with the circumferential direction. As the tire is being shaped during manufacture, namely during the transition from a cylindrical shape to a toric shape, the angle of the carcass reinforcers decreases significantly in the crown region of the tire, particularly in the vicinity of the equatorial plane.

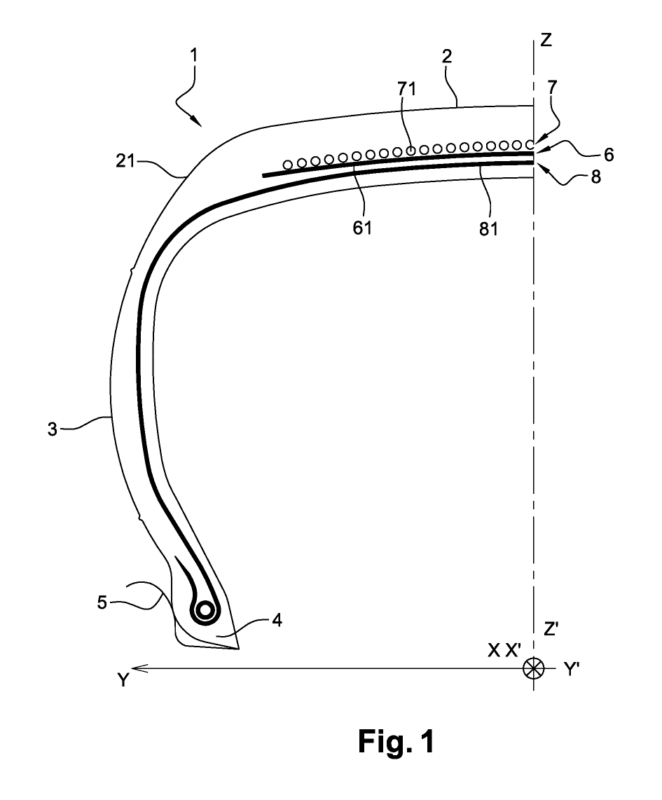

In what follows, the invention is described with the aid of the attached FIGS. 1 to 3 and of the examples described in Tables 1 to 5, all given by way of illustration.

FIG. 1 schematically shows the cross section of half a tire according to the invention, in a radial plane. As FIG. 1 shows, the tire 1 according to the invention comprises a tread 2, intended to come into contact with the ground and connected, at its axial ends 21, radially towards the inside, via two sidewalls 3, to two beads 4 intended to come into contact with a rim 5. The working reinforcement 6, radially on the inside of the tread 2, comprises a working layer 61 comprising metal working reinforcers (not depicted) coated in an elastomeric material, the said working reinforcers forming, with the circumferential direction YY′ of the tire, an angle A_{T} at least equal to 10°. The hoop reinforcement 7, radially on the inside of the tread 2, and radially on the outside of the working reinforcement 6, comprises a single hooping layer 71 comprising hoop reinforcers coated in an elastomeric material, the said hoop reinforcers forming, with the circumferential direction YY′, an angle A_{F} at most equal to 5°. The carcass reinforcement 8, joining the two beads 4 together, radially on the inside of the working reinforcement 6 and of the hoop reinforcement 7, comprises at least one carcass layer 81 comprising textile carcass reinforcers (not depicted) coated in an elastomeric material, the said carcass reinforcers forming, with the circumferential direction YY′, at least partially in the sidewalls 3, an angle A_{C2} at least equal to 85°.

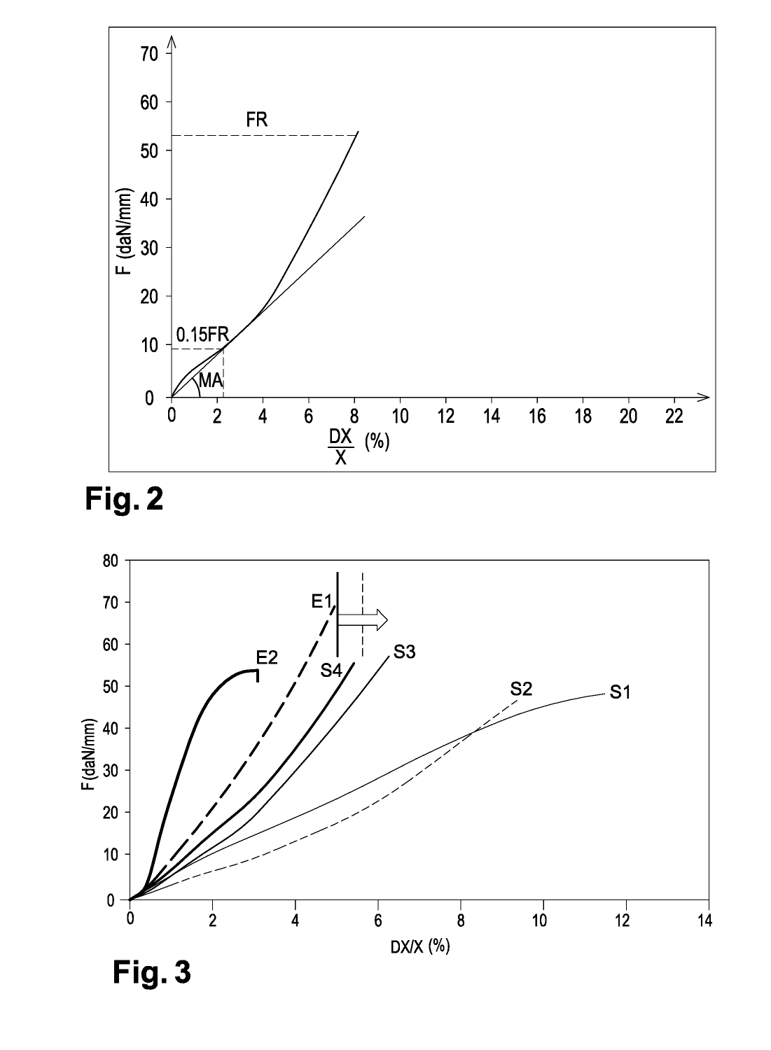

FIG. 2 shows a curve of the typical behaviour of a hooping layer, representing the tensile force F applied to the hooping layer, expressed in daN/mm, namely in daN per mm of axial width of the hooping layer, as a function of its deformation in extension DX/X. FIG. 2 in particular indicates the breaking force FR of the hooping layer and the secant extension modulus MA, measured at a force F equal to 0.15 times the breaking force FR and in a standardized manner characterizing the tensile stiffness of the hooping layer.

FIG. 3 shows various curves of the tensile behaviour of a hooping layer, showing the variation in the tensile force per mm of axial width of the hooping layer F, expressed in daN/mm, as a function of its deformation in extension DX/X, for various types of hoop reinforcers.

The curves in FIG. 3 were established for a hooping layer of a passenger vehicle tire of size 205/55 R 16, intended to be mounted on a 6.5J16 rim and to be inflated to a nominal pressure of 2.5 bar under “normal load” and 2.9 bar under “extra load”, in accordance with the ETRTO (European Tire and Rim Technical Organisation) standard. Curve S1 is the tensile curve for a hooping layer the hoop reinforcers of which are made up of 3, 440-tex strands (440/3) of PET with a balanced twist of 160 turns per metre (160 tpm), the pitch P of the reinforcers being equal to 1.31 mm Curve S2 is the tensile curve for a hooping layer the hoop reinforcers of which are of hybrid type and made up of a combination of a 334 tex PET and a 330 tex aramid, twisted together with a balanced twist of 270 turns per metre (270 tpm), the pitch P of the reinforcers being equal to 0.8 mm Curve S3 is the tensile curve for a hooping layer the hoop reinforcers of which are of hybrid type and made up of a combination of a 334 tex PET and a 330 tex aramid, twisted together with a balanced twist of 210 turns per metre (210 tpm), the pitch P of the reinforcers being equal to 1.23 mm Curve S4 is the tensile curve for a hooping layer the hoop reinforcers of which are made up of 2, 167-tex strands (167/2) of aramid, with a twist of 440 turns per metre (440 tpm), the pitch P of the reinforcers being equal to 0.87 mm Curve E1 is the tensile curve for a hooping layer the hoop reinforcers of which are made up of 2, 167-tex strands (167/2) of aramid, with a twist of 315 turns per metre (315 tpm), the pitch P of the reinforcers being equal to 0.87 mm Curve E2 is the tensile curve for a hooping layer the hoop reinforcers of which are made of metal cords made of steel made up of an assembly of 3 metal threads of diameter 0.26 mm, the pitch P of the reinforcers being equal to 0.85 mm The segment with an arrow in FIG. 3 indicates the specified minimum elongation at break of 5% beyond which the elongation at break of any hooping layer falling within the scope of the invention needs to lie. Curves S1, S2, S3 and S4 correspond to hooping layers that fall within the scope of the invention, whereas curves E1 and E2 correspond to comparative examples which do not fall within the scope of the invention.

The invention was studied more particularly for a passenger vehicle tire of size 205/55 R 16, intended to be mounted on a 6.5J16 rim and to be inflated to a nominal pressure of 2.5 bar under “normal load” and 2.9 bar under “extra load”, in accordance with the ETRTO (European Tire and Rim Technical Organisation) standard. Four alternative forms of embodiment of the invention, S1, S2, S3, S4, and two comparative examples El and E2 not falling within the scope of the invention, were compared.

Table 1 below shows the characteristics of the hooping layers of the two comparative examples E1 and E2 that do not fall within the scope of the invention and of the four alternative forms of embodiment of the invention S 1, S2, S3, S4, for a tire of size 205/55R16:

TABLE 1
Characteristics of the hooping layers in 205/55R16

| | | | | | | Force at break per | | De- | Secant | |
|---|---|---|---|---|---|---|---|---|---|---|
| | | Reinforcer | Reinforcer | Reinforcer | | mm of axial width of | 15% | formation | modulus MA | Elongation |
| | Hoop | Force at | diameter | pitch P | Ratio | the hooping layer FR | of FR | at 15% | at 15% of FR | at break |
| | reinforcer | break (daN) | D (mm) | (mm) | D/L | (daN/mm) | (daN/mm) | of FR (%) | (daN/mm) | layer AR(%) |
| Alternative | PET 440/3 | 83.5 | 1.29 | 1.69 | 3.2 | 49.4 | 7.4 | 2.15 | 345 | 11.6 |
| form S1 | 160 tpm | | | | | | | | | |
| Alternative | Aramid 330 + | 62.0 | 1.00 | 1.31 | 3.2 | 47.2 | 7.1 | 2.05 | 345 | 9.4 |
| form S2 | PET 334 | | | | | | | | | |
| | 270/270 tpm | | | | | | | | | |
| Alternative | Aramid 330 + | 71.5 | 0.94 | 1.23 | 3.2 | 58.0 | 8.7 | 1.45 | 600 | 6.3 |
| form S3 | PET 334 | | | | | | | | | |
| | 210/210 tpm | | | | | | | | | |
| Alternative | Aramid 167/2 | 48.5 | 0.66 | 0.87 | 3.2 | 56.0 | 8.4 | 1.16 | 724 | 5.4 |
| form S4 | 440 tpm | | | | | | | | | |
| Comparative | Aramid 167/2 | 60.0 | 0.66 | 0.87 | 3.2 | 69.4 | 10.4 | 1.05 | 991 | 5.0 |
| example E1 | 315 tpm | | | | | | | | | |
| Comparative | Metal cord 3.26 | 47.5 | 0.60 | 0.85 | 2.4 | 55.9 | 8.4 | 0.53 | 1582 | 3.6 |
| example E2 | | | | | | | | | | |

It should be noted that the inter-reinforcer distance L in the formula D/L is equal to the difference between the pitch P spacing between the reinforcers, measured between the axes of two consecutive reinforcers, and the diameter D of a reinforcer. This ratio is equal to 3.2 in all the cases studied, except for comparative example E2 where it is equal to 2.4.

According to Table 1, the forces at break per mm of axial width of the hooping layer FR of the hooping layers are respectively equal to 69.4 daN/mm and 55.9 daN/mm for comparative examples E1 and E2 outside of the scope of the invention and respectively equal to 49.4 daN/mm, 47.2 daN/mm, 58 daN/mm and 56 daN/mm for alternative forms of embodiment S1, S2, S3, S4, so they are all higher than the specified minimum force at break of 35 daN/mm, and even a higher than the 45 daN/mm specified preferred value for the minimum force at break. The elongations at break AR of the hooping layers are respectively equal to 5% and 3.6% for comparative examples E1 and E2 outside of the scope of the invention and respectively equal to 11.8% , 9.4%, 6.3% and 5.4% for alternative forms of embodiment S1, S2, S3, S4, so only alternative forms of embodiment S1, S2, S3, S4 exhibit deformations at break at least equal to the 5.5% specified preferred value for the elongation at break. Finally, the secant extension modulus values at 15% of the force at break of the hooping layer FR are respectively equal to 991 daN/mm and 1582 daN/mm for comparative examples E1 and E2 outside of the scope of the invention and respectively equal to 345 daN/mm, 606 daN/mm, 600 daN/mm and 724 daN/mm for alternative forms of embodiment S1, S2, S3, S4, so only alternative forms of embodiment S1, S2, S3, S4 exhibit secant modulus values comprised between the 300 daN/mm and 900 daN/mm specified preferred values for the secant extension modulus at 15% of the force at break.

Table 2 below shows the types of reinforcers and the angles, formed by the said reinforcers, for the carcass, working and hoop reinforcements, for a passenger vehicle tire of size 205/55R16, for the two comparative examples E1 and E2 not falling within the scope of the invention and the four alternative forms of embodiment of the invention S1, S2, S3, S4:

TABLE 2
Types and angles of the reinforcers of carcass, working and hoop reinforcements
in 205/55R16

| | | Angle A_{C2} in the | Type of | Angle A_{T} in the | | Angle A_{F} in the |
|---|---|---|---|---|---|---|
| | Type of carcass | equatorial | working | equatorial | Type of hoop | equatorial |
| | reinforcer | plane (°) | reinforcer | plane (°) | reinforcer | plane (°) |
| Reference of | PET 144/2 | 90 | Steel 2.30 | +/−25 | Nylon N140/2 | 0 |
| the prior art R | 290 tpm | | P = 1.2 mm | | 250/250 tpm | |
| Alternative | PET 144/2 | 67 | Steel 2.30 | −40 | PET 440/3 | 0 |
| form S1 | 290 tpm | | P = 0.9 mm | | 160 tpm | |
| Alternative | PET 144/2 | 67 | Steel 2.30 | −40 | Aramid 330 + | 0 |
| form S2 | 290 tpm | | P = 0.9 mm | | PET 334 | |
| | | | | | 270/270 tpm | |
| Alternative | PET 144/2 | 67 | Steel 2.30 | −40 | Aramid 330 + | 0 |
| form S3 | 290 tpm | | P = 0.9 mm | | PET 334 | |
| | | | | | 210/210 tpm | |
| Alternative | PET 144/2 | 67 | Steel 2.30 | −40 | Aramid 167/2 | 0 |
| form S4 | 290 tpm | | P = 0.9 mm | | 440 tpm | |
| Comparative | PET 144/2 | 67 | Steel 2.30 | −40 | Aramid 167/2 | 0 |
| example E1 | 290 tpm | | P = 0.9 mm | | 315 tpm | |
| Comparative | PET 144/2 | 67 | Steel 2.30 | −40 | Metal cord 3.26 | 0 |
| example E2 | 290 tpm | | P = 0.9 mm | | | |

According to Table 2, the carcass reinforcement, in all configurations, is made up of a single carcass layer the carcass reinforcers of which are made up of 2, 144-tex strands (144/2) of PET with a twist of 290 turns per metre (290 tpm). For the reference of the prior art R, the carcass reinforcers of the carcass layer form, with the circumferential direction and in the equatorial plane, an angle A_{C2} equal to 90°. For all the other configurations, the carcass reinforcers of the carcass layer form, with the circumferential direction and in the equatorial plane, an angle A_{C2} equal to 67°.

The working reinforcement, for the reference of the prior art, is made up of two working layers the working reinforcers of which are metal cords made of steel containing 0.7% carbon, made up of 2 threads having a diameter equal to 0.30 mm, and laid at a pitch P equal to 1.2 mm, the said working reinforcers forming, with the circumferential direction, an angle equal to 25° and crossed from one working layer to the next. The working reinforcement, for all the other configurations studied, is made up of a single working layer the working reinforcers of which are metal cords made of steel containing 0.7% carbon, made up of 2 threads having a diameter equal to 0.30 mm, and laid at a pitch P equal to 0.9 mm, the said working reinforcers forming, with the circumferential direction, an angle equal to −40°.

Table 3 hereinbelow presents theoretical results relating to the radial Rxx and shear

Gxy stiffnesses, derived from analytical calculations, and theoretical burst pressures for a tire of size 205/55R16:

TABLE 3
Stiffnesses and burst pressures calculated on 205/55R16

| | Radial stiffness | Shear stiffness | Burst pressure |
|---|---|---|---|
| | Rxx as a | Gxy as a | as a |
| | relative value | relative value | relative value |
| | (%) | (%) | (%) |
| Reference of the | 100 | 100 | 100 |
| prior art R | | | |
| Alternative | 80 | 14 | 82 |
| form S1 | | | |
| Alternative | 52 | 13 | 76 |
| form S2 | | | |
| Alternative | 82 | 14 | 91 |
| form S3 | | | |
| Alternative | 90 | 15 | 90 |
| form S4 | | | |
| Comparative | 113 | 15 | 110 |
| example E1 | | | |
| Comparative | 1001 | 18 | 85 |
| example E2 | | | |

The radial stiffness Rxx, expressed in daN/mm, is the radial force that needs to be applied to the tire in order to obtain a 1 mm radial displacement of its crown. The shear stiffness Gxy, expressed in daN/mm, is the axial force that needs to be applied to the tire in order to obtain a 1 mm axial displacement of its crown. The theoretical burst pressure of the tire, expressed in bar, is a characteristic of the ability of the tire to withstand pressure. The radial stiffness Rxx and shear stiffness Gxy characteristics, and the burst pressure, are expressed in the form of a relative value with respect to the corresponding characteristics of the prior-art reference R, considered as the base 100.

According to Table 3, the alternative forms S1, S3 and S4 exhibit values of radial stiffness Rxx and of burst pressure which are close to the values obtained for the prior-art reference R. By contrast, the shear stiffnesses Gxy are very much lower than the reference R, which is to be expected given the fact that the working reinforcement comprises just one working layer.

Table 4 hereinbelow shows the results of measurements and tests relating to the various tire designs studied, for a tire of size 205/55 R16:

TABLE 4
Cornering stiffnesses, breaking energy and
burst pressures measured on 205/55R16

| | | | Burst pressure |
|---|---|---|---|
| | Cornering | Breaking energy | of the tire |
| | stiffness as a | (J) for an | inflated |
| | relative value | inflation pressure | with water |
| | (%) | of 2.2 bar | (bar) |
| Reference of the | 100 | >588 J | >16 bar |
| prior art R | | | |
| Alternative form S1 | 98 | >588 J | >16 bar |
| Alternative form S2 | — | >588 J | >16 bar |
| Alternative form S3 | 110 | >588 J | >16 bar |
| Alternative form S4 | — | >588 J | >16 bar |
| Comparative | 110 | >588 J | >16 bar |
| example E1 | | | |
| Comparative | 107 | >588 J | >16 bar |
| example E2 | | | |

The cornering stiffness Dz of a tire is the axial force applied to the tire in order to generate a 1° rotation of the tire about a radial direction. In Table 4, the cornering stiffness is expressed in the form of a relative value, namely as a percentage of the prior-art reference considered as base 100, for a tire of size 205/55R16, subjected to a load equal to 0.8 times its nominal load, within the meaning of the ETRTO standard, the said nominal load being equal to 4826 N.

The perforation energy or breaking energy is measured by indentation by a cylindrical or polar obstacle having a diameter of 19 mm, the tire being inflated to a pressure equal to 2.2 bar (extraload condition). During the course of this test, the energy is measured at the moment that the polar perforates the crown and is compared against a minimum threshold value. For a tire of this size, the minimum threshold value that is to be respected to meet the so-called “Extraload” requirement of the standard cover is equal to 588 J.

The burst-pressure test on the tire is carried out on a tire inflated with water. The minimum threshold value adapted to guarantee the tire's ability to withstand the pressure with a satisfactory margin of safety is taken as 16 bar.

According to Table 4, in comparison with the results obtained for the reference R, the alternative forms of the invention S1 and S3 and comparative examples E1 and E2 exhibit a cornering stiffness Dz at the same level as the reference (between 98% and 110%). In addition, all the configurations tested have a breaking energy value higher than the minimum threshold value of 588 J and a burst pressure higher than the minimum threshold value of 16 bar. It should be noted that these results are obtained for lightened tire structures comprising just one working layer rather than two working layers that are crossed with respect to one another in the case of the reference R.

Table 5 hereinbelow presents the results of tests of running over cobbles, aimed at quantifying the fatigue strength of the hoop reinforcers under conditions of severe hammering of the tread. More specifically, for each configuration tested, the number of zones in which the hooping layer has broken is counted after the tire has been de-capped.

Table 5, for the hooping layer of each of the configurations tested, gives a reminder of the secant extension modulus MA, for an applied force F equal to 15% of the breaking force FR, the elongation at break AR and shows the corresponding number of breakage zones, for a tire of size 205/55R16.

TABLE 5
Number of zones of breakage of the hooping layer,
after test of running over cobbles, on 205/55R16

| | | | Number of zones |
|---|---|---|---|
| | | | of breakage of |
| | Secant extension | | the hooping |
| | modulus MA | Elongation | layer, after |
| | at 15% FR | at break AR | test of running |
| | (daN/mm) | (%) | over cobbles |
| Reference of the | — | — | 10 |
| prior art R | | | |
| Alternative form S1 | 345 | 11.60 | 0 |
| Alternative form S2 | 606 | 9.40 | 0 |
| Alternative form S3 | 600 | 6.26 | 2 |
| Alternative form S4 | 724 | 5.39 | 29 |
| Comparative | 991 | 4.96 | 49 |
| example E1 | | | |
| Comparative | 1582 | 3.60 | 120 |
| example E2 | | | |

According to Table 5, the prior-art reference R exhibits 10 zones of breakage of the hooping layer. The best configurations as regards the test of running over cobbles are the alternative forms of embodiment S1, S2 and S3, because the number of zones of breakage of the hooping layer is zero or near-zero. These 3 alternative forms of embodiment S1, S2 and S3 have in common a secant extension modulus MA, for an applied force F equal to 15% of the force at break FR, comprised between 300 daN/mm and 700 daN/mm, and an elongation at break AR greater than 5.5%. The alternative form of embodiment S4, with a secant extension modulus MA, for an applied force F equal to 15% of the force at break FR, comprised between 700 daN/mm and 900 daN/mm and an elongation at break AR comprised between 5% and 5.5%, is not as good as the previous ones, because the number of breakage zones in its hooping layer rises to 29. Finally, comparative examples E1 and E2, with a secant extension modulus MA, for an applied force F equal to 15% of the force at break FR, greater than 900 daN/mm and an elongation at break AR less than 5%, exhibit a number of hooping layer breakage zones respectively equal to 49 and to 120, which is a performance that is appreciably downgraded by comparison with the prior art R.

In the field of passenger vehicle tires, the invention is not restricted to the carcass reinforcers and to the working reinforcers described hereinabove. The carcass reinforcers may be made of any type of textile material such as, for example and non-exhaustively, PET, aramid, nylon or any combination of these materials. Working reinforcers are metal cords which may be of various assemblies such as, for example and non-exhaustively, cords of formula 3.26 (assembly of 3 threads, 0.26 mm in diameter), 3.18 (assembly of 3 threads, 0.18 mm in diameter), 2.30 (assembly of 2 threads, 0.30 mm in diameter, with a helix pitch of 14 mm) or mono-filaments 0.40 mm in diameter.

The invention is not restricted to a tire for a passenger vehicle but may be extended, non-exhaustively, to tires intended to be fitted to 2-wheeled vehicles such as motorbikes, vehicles of the heavy duty or construction plant type.

1. A tire for a passenger vehicle, comprising:
a tread intended to come into contact with the ground and connected, at its axial ends, radially towards the inside, via two sidewalls, to two beads intended to come into contact with a rim;
a working reinforcement, radially on the inside of the tread, and comprising at least one working layer comprising metal working reinforcers coated in an elastomeric material, the said working reinforcers forming, with a circumferential direction of the tire, an angle A_{T} at least equal to 10°;
a hoop reinforcement, radially on the inside of the tread, and radially adjacent to the working reinforcement, and comprising a single hooping layer comprising hoop reinforcers coated in an elastomeric material, said hoop reinforcers forming, with the circumferential direction, an angle A_{F} at most equal to 5°;
a carcass reinforcement, joining the two beads together, radially on the inside of the working reinforcement and of the hoop reinforcement, and comprising at least one carcass layer comprising textile carcass reinforcers coated in an elastomeric material, said carcass reinforcers forming, with the circumferential direction, at least partially in the sidewalls, an angle A_{C1} at least equal to 85°;
wherein the hooping layer has a force at break per mm of axial width of the hooping layer FR at least equal to 35 daN/mm, in that wherein the hooping layer (71) has an elongation at break AR at least equal to 5%, in that wherein the hooping layer has a secant extension modulus MA at least equal to 250 daN/mm, for an applied force F equal to 15% of the force at break FR of the said hooping layer, in that wherein the working reinforcement comprises a single working layer the working reinforcers of which form, with the circumferential direction, an angle A_{T} at least equal to 30° and at most equal to 50°, and in that wherein the carcass reinforcers of the at least one carcass layer form, with the circumferential direction and in the equatorial plane, an angle AC_{C2} at least equal to 55° and at most equal to 80° and having an orientation the opposite of that of the angle A_{T} of the working reinforcers so that the carcass reinforcers and the working reinforcers constitute a triangulation.

2. The tire according to claim 1, wherein the hooping layer has a force at break per mm of axial width of the hooping layer FR at least equal to 45 daN/mm.

3. The tire according to claim 1, wherein the hooping layer has an elongation at break AR at least equal to 5.5%.

4. The tire according to claim 1, wherein the hooping layer has a secant extension modulus MA at least equal to 300 daN/mm, for an applied force F equal to 15% of the force at break FR of the said hooping layer.

5. The tire according to claim 1, wherein the hooping layer has a secant extension modulus MA at most equal to 900 daN/mm, for an applied force F equal to 15% of the force at break FR of the said hooping layer.

6. The tire according to claim 1, wherein the hooping layer has a secant extension modulus MA at most equal to 700 daN/mm, for an applied force F equal to 15% of the force at break FR of the said hooping layer.

7. The tire according to claim 1, the hooping layer comprising hoop reinforcers having a diameter D and spaced one from the next by an inter-reinforcer distance L, wherein the ratio D/L between the diameter D of a hoop reinforcer and the distance L separating two consecutive hoop reinforcers is at least equal to 1 and at most equal to 8.

8. The tire according to claim 1, the hooping layer comprising hoop reinforcers having a diameter D and spaced one from the next by an inter-reinforcer distance L, wherein the ratio D/L between the diameter D of a hoop reinforcer and the distance L separating two consecutive hoop reinforcers is at least equal to 2 and at most equal to 5.

9. The tire according to claim 1, wherein the hoop reinforcers comprise a textile material such as an aromatic polyamide or aramid, an aliphatic polyamide or nylon, a polyester such as a polyethylene terephthalate (PET), a polyethylene naphthenate (PEN), a polyketone or a textile material comprising cellulose fibres such as rayon or lyocell.

10. The tire according to claim 9, wherein the hoop reinforcers comprise a combination of at least two distinct textile materials.

11. The tire according to claim 10, wherein the hoop reinforcers are made of the combination of an aromatic polyamide or aramid and of a polyethylene terephthalate (PET).

12. The tire according to claim 1, the hooping and working layers respectively having an axial width L_{F} and L_{T}, in which wherein the hooping layer has an axial width L_{F} less than the axial width L_{T} of the working layer.

13. The tire according to claim 1, wherein the working reinforcers of the working layer form, with the circumferential direction, an angle A_{T} at least equal to 35° and at most equal to 45°.

14. The tire according to claim 1, wherein the carcass reinforcers of the at least one carcass layer form, with the circumferential direction and in the equatorial plane, an angle A_{C2} at least equal to 60° and at most equal to 70°.

15. The tire according to claim 1, the hooping and working layers respectively having an axial width L_{F} and L_{T}, wherein the hooping layer has an axial width L_{F} less than the axial width L_{T} of the working layer when the hooping layer is radially on the outside of the working layer.
